(19) United States
(12) Patent Application Publication
(10) Pub. No.: US 2007/0106689 A1
(43) Pub. Date: May 10, 2007

(54) XML data reduction engine (XRE)

(75) Inventor: Alan N. Slater, San Jose, CA (US)

Correspondence Address: Alan N. Slater, 2197 Wynfair Ridge Way, San Jose, CA, 95138, US

(73) Assignee: Safyre Solution Inc., San Jose, CA (US)

(21) Appl. No.: 11/267,879

(22) Filed: Nov. 7, 2005

(51) Int. Cl. G06F 17/00

(52) U.S. Cl. 707/104.1

(57) ABSTRACT

This invention provides a method and system for semantic interoperability through an innovative method to transmit a smaller set of XML data using unique UDEF Identifier tagging and common objects model.

### BACKGROUND OF THE INVENTION

UDEF is an evolving standard global method for categorizing data element concepts (as defined by ISO/IEC 11179) that exist across multiple applications. It assigns each data element concept an alphanumeric tag plus a semantically rich name—that in most cases can stand-alone without requiring a separate definition. For example, “Purchase Order Number” found in an invoice from industry to the government is a commonly encountered data element concept. This concept has a UDEF tag d.t.2_{—}13.35.8 and associated UDEF name

Purchase.Order.DOCUMENT_Government.Assigned.IDENTIFIER. The UDEF name and associated ID pair is similar in several ways to the Domain Name System (DNS) used to manage computer-sensible IP addresses in 123.456.789 format and to associate them to user-friendly formats such as www.company.com If adopted on a global scale, the UDEF could become a Semantic DNS.

The present invention is directed to a method and system for providing semantic interoperability through an innovative method to transmit data using unique UDEF Identifier (e.g. UDEF) tagging.

### SUMMARY OF THE INVENTION

This invention provides for the automation of e-business objects to interact with enterprise applications and external partners which assures that each business achieves interoperability and more effectively manage business processes.

### BRIEF DESCRIPTION OF THE DRAWINGS

FIG. 1 is a simple design time diagram.

FIG. 2 is a more detailed design time diagram.

FIG. 3 is a run time diagram of a transmission.

FIG. 4 is a run time diagram of the data transformation.

FIG. 5 is a diagram of the common data element concept with its UDEF name and associated UDEF tag.

FIG. 6 is a diagram of the automation of e-business objects.

### DETAILED DESCRIPTION OF THE PREFERRED EMBODIMENT

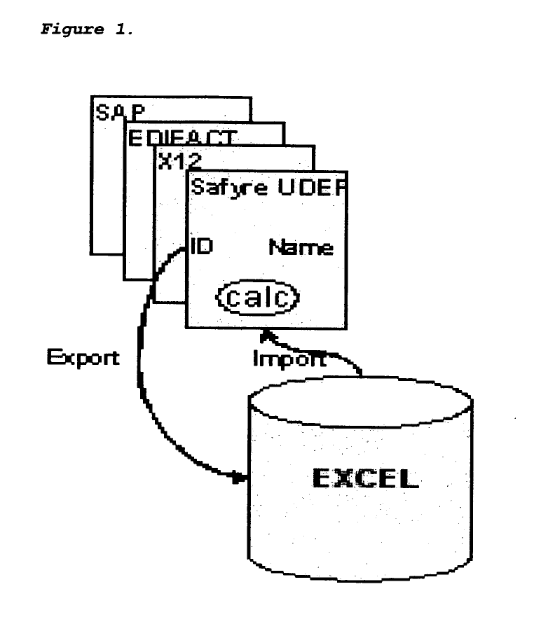

FIG. 1 briefly illustrates an example of what needs to be done when a document doesn't contain an UDEF Identifier in which the XRE recognizes. The Safyre Enterprise Interoperability Tool (not illustrated here) is used to covert a document into a common object that contains UDEF Identifiers.

In this illustration an Excel document was imported, the fields were assigned a UDEF name and UDEF tag, and the UDEF Identifier was calculated. The UDEF Identifier is referenced by the XRE when transmitting and receiving messages.

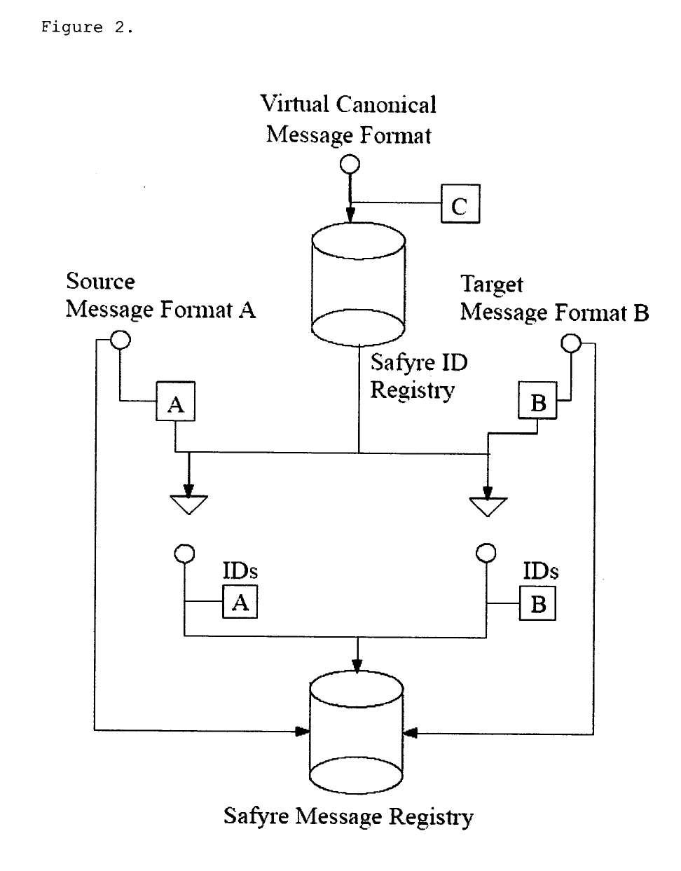

FIG. 2 The design time process involves the following:

A message meta data dictionary is built. The dictionary data is normalized. A common data model is built for any new data. A canonical schema is derived. If necessary, gaps in the data are submitted to the UDEF Open Group. The UDEF Open Group will assign an UDEF tag and name for the data object. We receive the UDEF Tag and Name from UDEF Open Group and assign it to the normalized dictionary. The UDEF tags are assigned to a standards-based and application message meta-data dictionary (X12, Edifact, HL7, SAP, Oracle, etc.)

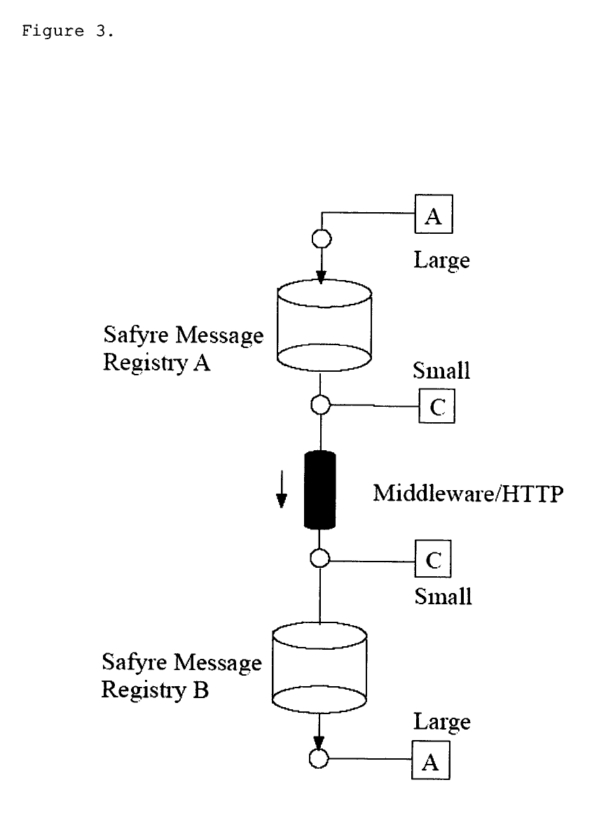

FIG. 3 illustrates what happens at run time when a message is received and then transmitted.

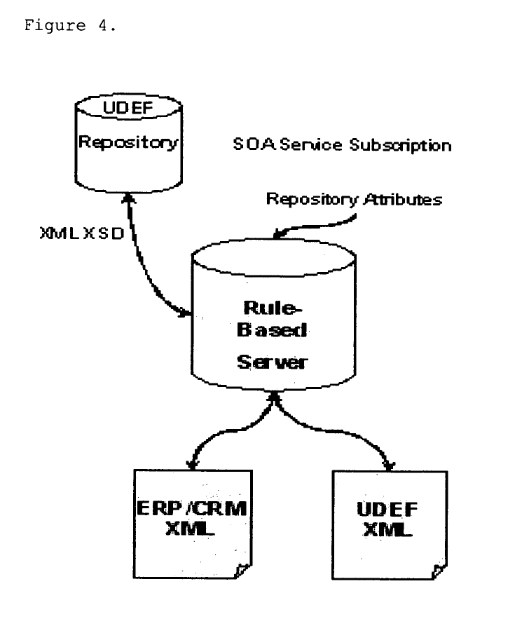

FIG. 4 illustrates an ERP/CRM message transformation. We Automap the canonicals to applications and standards. The auto mapping process involves the rules server, UDEF repository and registry, and the Safyre UDEF identifier document. The server rules are based on business processes (SOX, Orders-to-Cash, etc.).

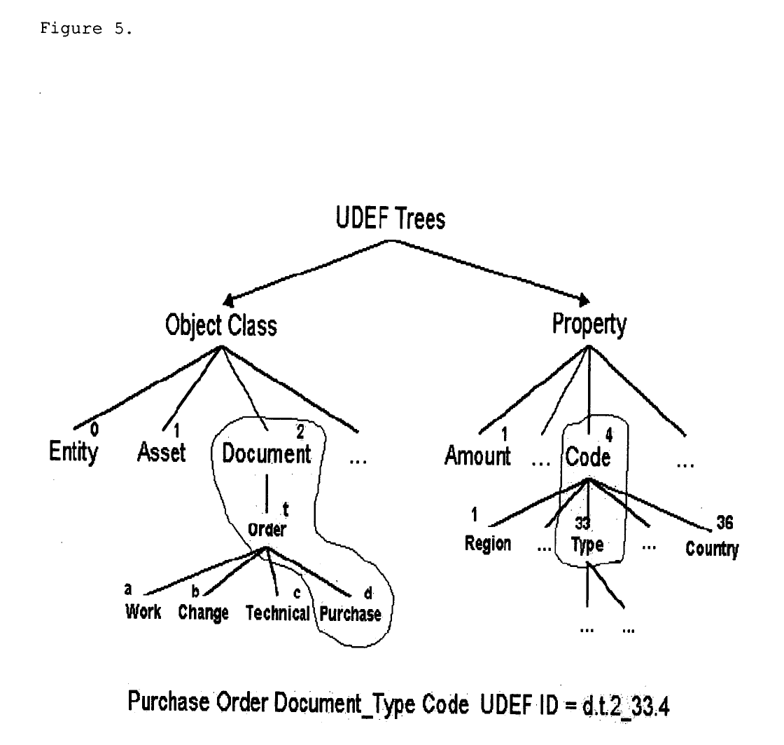

FIG. 5 illustrates a few extracts from the UDEF and illustrates a common data element concept with its UDEF name and associated UDEF tag.

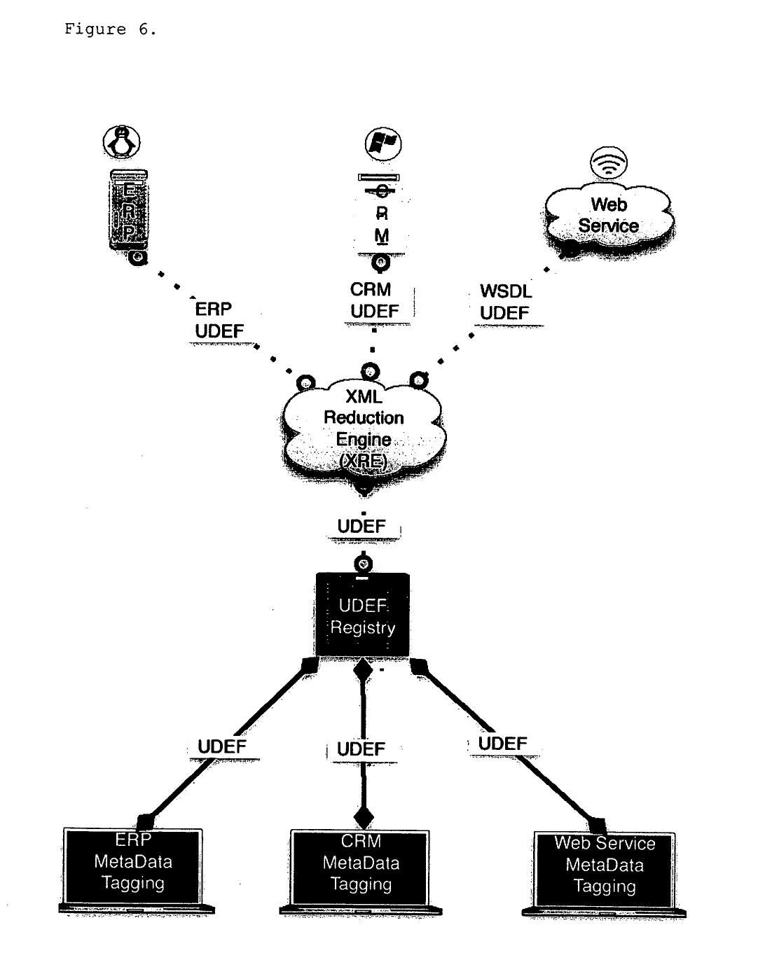

FIG. 6 briefly illustrates the automation of e-business objects interacting with enterprise applications.

What is claimed is:

1. A method and system for providing semantic interoperability through an innovative method to transmit data using unique UDEF Identifier (e.g., UDEF) tagging.

2. The method of claim 1, wherein the method and system of tagging xml data means large amounts of xml data doesn't have to be transmitted.

3. The method of claim 1, wherein provides for the decoupling of ERP and CRM applications to the customer data management process.

4. Provide plug & play flexibility through common object modeling and XML content optimization through the use of unique identifiers and Safyre's XML REDUCTION ENGINE (XRE).

5. Single point of entry for all customer master data tied directly to the BOD (Business Object Document) architecture.
